(19) United States
(12) Patent Application Publication
(10) Pub. No.: US 2012/0092381 A1
(43) Pub. Date: Apr. 19, 2012

(54) Snapping User Interface Elements Based On Touch Input

(75) Inventors: Paul Armistead Hoover, Bothell, WA (US); Vishnu Sivaji, Seattle, WA (US); Jarrod Lombardo, Bellevue, WA (US); Daniel John Wigdor, Seattle, WA (US)

(73) Assignee: Microsoft Corporation, Redmond, WA (US)

(21) Appl. No.: 12/907,887

(22) Filed: Oct. 19, 2010

(51) Int. Cl. G09G 5/00

(52) U.S. Cl. 345/662

(57) ABSTRACT

An invention is disclosed for using touch gestures to zoom a video to full-screen. As the user reverse-pinches on a touch-sensitive surface to zoom in on a video, the invention tracks the amount of a zoom. When the user has zoomed to the point where one of the dimensions (height or width) of the video reaches a threshold (such as some percentage of a dimension of the display device—e.g. the width of the video reaches 80% of the width of the display device), the invention determines to display the video in full-screen, and “snaps” the video to full-screen. The invention may do this by way of an animation, such as expanding the video to fill the screen.

### BACKGROUND

There are ways that users may provide input to a computer system through direct manipulation, where the user interacts with user interface elements without aid of an on-screen cursor. This direct manipulation is in contrast to indirect manipulation, where an on-screen cursor is manipulated by a user, such as with a mouse or a scroll wheel. Examples of forms of direct manipulation include touch input to a touch-sensitive surface with a finger or stylus, digitizer pen input to a digitizer surface, voice input captured by a microphone, and body gesture or eye-tracking input provided to a motion capture device (such as the MICROSOFT KINECT motion capture device).

Referring specifically to touch input, users may provide input to a computer system through touching a touch-sensitive surface, such as with his or her finger(s), or a stylus. An example of this touch-sensitive surface is a track pad, like found in many laptop computers, in which a user moves his finger along a surface, and those finger movements are reflected as cursor or pointer movements on a display device. Another example of this touch-sensitive surface is a touch screen, like found in many mobile telephones, where a touch-sensitive surface is integrated into a display device, and in which a user moves his finger along the display device itself, and those finger movements are interpreted as input to the computer.

There are also general techniques for using multiple fingers at the same time as input to a computer system. These techniques are sometimes referred to as “multi-point” or “multi-touch.” A “multi-point” gesture commonly is one that involves multiple fingers or other input devices, whereas a “multi-touch” gesture commonly is one that involves interacting with multiple regions of a touch surface, though the term is commonly used as synonymous with “multi-point.” As used herein, the terms will both be used to mean a gesture that comprises the use of multiple fingers or other input devices.

An example of such a multi-point gesture is where a user presses two fingers on a touch-sensitive surface and drags them down, and this input is interpreted as scrolling the active window on the desktop down. Current techniques for user input to a touch-sensitive surface and other forms of direct manipulation are limited and have many problems, some of which are well known.

### SUMMARY

It would therefore be an improvement to provide an invention for improved direct manipulation input. The present invention relates to ways to manipulate video, images, text columns or other elements embedded within a window or page, such as a web page.

There are known techniques for controlling the size or zoom of a window generally. For instance, a user may tap twice on an area of a touch-sensitive surface to zoom in on part of the display that corresponds to the area tapped. There are also “pinch” and “reverse-pinch” gestures that enable a user to zoom out and zoom in, respectively. In a pinch gesture, a user puts two fingers on the touch-sensitive surface and converges them (drags them closer together), which generally is interpreted as input to zoom out, centered on the area being “pinched.” In a reverse-pinch gesture, a user puts two fingers on the touch-sensitive surface and then diverges them (drags them apart), which generally is interpreted as input to zoom in, centered on the area being “reverse-pinched.”

The problem with the tap, pinch, and reverse-pinch gestures is that they provide a poor means for a user to achieve a common goal—to “snap” an element of a user interface (such as a video, an image, or a column of text) to a border (frequently the edge of a display area). A scenario that benefits greatly from snapping techniques is zooming a video to full-screen—snapping the outer edges of the video to the edges of the display area (the display area comprising a display on which the video is displayed, or a distinct portion of that display, such as a window within that display). A user may use a reverse-pinch gesture to zoom a video to full-screen, but it is difficult to do this exactly because of the impreciseness of using one's fingers to manipulate the video an exact number of pixels—the user may zoom the video past full-screen, meaning that some of the video is not displayed, or the user may not zoom the video to full-screen, meaning that the video does not fill the screen, as is desired.

Furthermore, even where a current technique, such as a tap on an element, causes the element to snap to a border, this technique harms the user experience because it denies the user a belief that he is in control of the manipulation. When the user taps on an element, it may be that rather than snapping this element to a border, a second element that encloses this element is what is snapped to the border. In such a scenario, the user is left feeling as if he is not controlling the computer.

Techniques for indirect manipulation of elements for snapping work poorly in the direct manipulation environment. Where a user snaps or unsnaps an element with a cursor, there is no direct relationship between the position of the user's hand that moves the mouse (or how the user otherwise provides indirect input) and the cursor and element being manipulated. Since the user is not manipulating the element directly, the user does not notice that, when an element unsnaps, it is does not “catch up” to the user's hand position, which has continued to move even while the element was snapped. Rather, it merely unsnaps. This does not work in a direct manipulation scenario, because now the user's finger (for instance) on the touch screen leads the element by a distance. To provide a better user experience in the direct manipulation scenario, the element must catch up to the user's finger (or other form of direct manipulation) after unsnapping.

The present invention overcomes these problems. In an example embodiment, as the user reverse-pinches to zoom in on a video, the invention tracks the amount of a zoom. When the user has zoomed to the point where one of the dimensions (height or width) of the video reaches a threshold (such as some percentage of a dimension of the display device—e.g. the width of the video reaches 80% of the width of the display device), the invention determines to display the video in full-screen, and “snaps” the video to full-screen. The invention may do this by way of an animation, such as expanding the video to fill the screen.

In another example embodiment, a user performs direct manipulation input to move an element toward a threshold at which a snap is applied. When the element reaches the snap threshold (such as a position on screen), it is snapped to a snap position. As the user continues to provide direct manipulation to the element, it remains snapped to the snap position until the user's direct manipulation reaches an unsnap threshold (such as another position on screen). The element is then unsnapped from the snap threshold, and the element is moved faster than the direct manipulation until the element catches up to the direct manipulation. For instance, where a finger on a touch-screen is used to move an element by pressing down on a part of the screen where the element is displayed, the element catches up to the direct manipulation when it resumes being displayed on a portion of the touch-screen touched by the finger.

The primary embodiment of the invention discussed herein involves the manipulation of a dimension of a video. As used herein, mentions of dimension should be read to also include a change in the position of the video. Such a scenario where a change in the position of the video result in snapping may be where the position of a video is moved so that it is sufficiently close to the edge of a display area that it is determined that the video is to be snapped to the edge of the display area.

There are other aspects of the invention, which are described in the detailed description of the drawings. Such aspects include snapping an element to a border by manipulating its pitch or yaw, or by manipulating its translation (its center point within a region).

As used herein, “video” may refer to a video itself, or the container in which a video may be played, even though a video may not be played in the container at the time the user makes the full-screen zoom gesture, or other gesture. It may be appreciated that the invention may be applied to still images, text, and other elements, as well as video, though video is discussed herein as the primary embodiment.

It may also be appreciated that a video may not have the same dimensions, or aspect ratio, as the display device upon which is displayed. For instance, the video may have a 4:3 aspect ratio (where the width of the video is 4/3 times greater than the height of the video) and it may be displayed on a display device with a 16:9 aspect ratio. In this scenario, as the video expands, its height may reach the height of the display before its width reaches the width of the display. Thus, in this scenario, full screen may be considered filling the video such that height of the video is set to be as large as the height—“limiting dimension” of the display device. Then, the rest of the display device may be filled with something other than the video, such as black (sometimes referred to as “black bars”).

In another scenario where the aspect ratio of the video differs from the aspect ratio of the display device, full screen may comprise “cropping” the video, where the video is expanded until every pixel of the display is occupied by the video, even though some of the video is not displayed. Using the above example of a 4:3 video and a 16:9 display device, the video may be expanded until the width of the video equals the width of the display device. This will result in parts of the top and bottom of the video to be “cut off,” or not displayed, though some of the video will occupy all of the display device. This is sometimes referred to as “filling” the screen.

Other embodiments of an invention for using touch gestures to zoom a video to full-screen exist, and some examples of such are described with respect to the detailed description of the drawings.

### BRIEF DESCRIPTION OF THE DRAWINGS

The systems, methods, and computer-readable media for using touch gestures to zoom a video to full-screen are further described with reference to the accompanying drawings in which:

FIG. 1 depicts an example general purpose computing environment in which an aspect of an embodiment of the invention can be implemented.

FIG. 2 depicts an example computer including a touch-sensitive surface in which an aspect of an embodiment of the invention can be implemented.

FIG. 3 depicts an example touch-sensitive display that displays a video, which a user zooms using a reverse-pinch gesture.

FIG. 4 depicts the example touch-sensitive display of FIG. 3, as the user continues to zoom using a reverse-pinch gesture.

FIG. 5 depicts the example touch-sensitive display of FIG. 4, after the user has zoomed using a reverse-pinch gesture to reach a threshold where the invention causes the video to be displayed in a full-screen mode.

FIG. 6 depicts an example graph that compares the movement of a user's finger(s) over time and the position of an element manipulated by the user.

FIGS. 7, 8, 9, and 10 depict the position of a user's finger(s) and of an element manipulated by the user at four respective different points in time relative to the graph of FIG. 6.

FIG. 11 depicts another example graph that compares the movement of a user's finger(s) over time and the position of an element manipulated by the user.

FIG. 12 depicts another example graph that compares the movement of a user's finger(s) over time and the position of an element manipulated by the user.

FIGS. 13, 14, 15, and 16 depict the position of a user's finger(s) and of an element manipulated by the user in a different manner than depicted in FIGS. 7-10 at four respective different points in time relative to the graph of FIG. 6.

FIG. 17 depicts example operational procedures for using touch gestures to zoom a video to full-screen.

### DETAILED DESCRIPTION OF ILLUSTRATIVE EMBODIMENTS

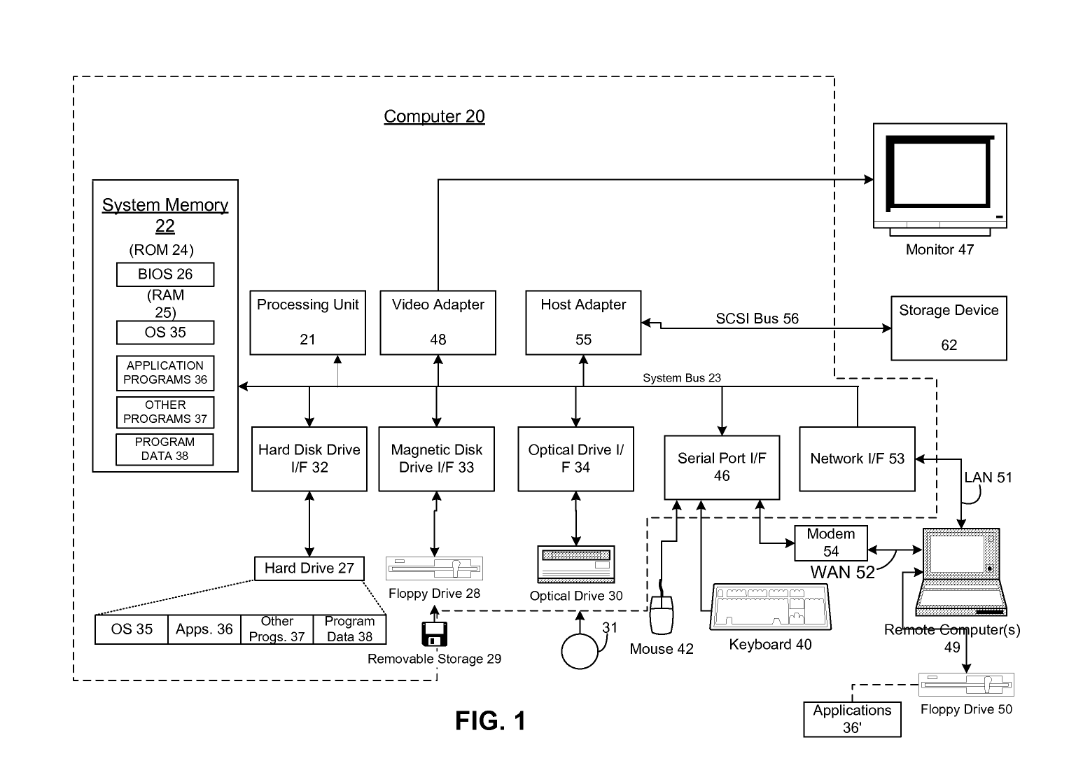

Embodiments may execute on one or more computer systems. FIG. 1 and the following discussion are intended to provide a brief general description of a suitable computing environment in which the disclosed subject matter may be implemented.

The term processor used throughout the description can include hardware components such as hardware interrupt controllers, network adaptors, graphics processors, hardware based video/audio codecs, and the firmware used to operate such hardware. The term processor can also include microprocessors, application specific integrated circuits, and/or one or more logical processors, e.g., one or more cores of a multi-core general processing unit configured by instructions read from firmware and/or software. Logical processor(s) can be configured by instructions embodying logic operable to perform function(s) that are loaded from memory, e.g., RAM, ROM, firmware, and/or mass storage.

Referring now to FIG. 1, an exemplary general purpose computing system is depicted. The general purpose computing system can include a conventional computer 20 or the like, including at least one processor or processing unit 21, a system memory 22, and a system bus 23 that communicative couples various system components including the system memory to the processing unit 21 when the system is in an operational state. The system bus 23 may be any of several types of bus structures including a memory bus or memory controller, a peripheral bus, and a local bus using any of a variety of bus architectures. The system memory can include read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are shown as connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as flash memory cards, digital video disks, random access memories (RAMs), read only memories (ROMs) and the like may also be used in the exemplary operating environment. Generally, such computer readable storage media can be used in some embodiments to store processor executable instructions embodying aspects of the present disclosure.

A number of program modules comprising computer-readable instructions may be stored on computer-readable media such as the hard disk, magnetic disk 29, optical disk 31, ROM 24 or RAM 25, including an operating system 35, one or more application programs 36, other program modules 37 and program data 38. Upon execution by the processing unit, the computer-readable instructions cause the actions described in more detail below to be carried out or cause the various program modules to be instantiated. A user may enter commands and information into the computer 20 through input devices such as a keyboard 40 and pointing device 42. Other input devices (not shown) may include a microphone, joystick, game pad, satellite dish, scanner or the like. These and other input devices are often connected to the processing unit 21 through a serial port interface 46 that is coupled to the system bus, but may be connected by other interfaces, such as a parallel port, game port or universal serial bus (USB). A monitor 47, display or other type of display device can also be connected to the system bus 23 via an interface, such as a video adapter 48. In addition to the display 47, computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

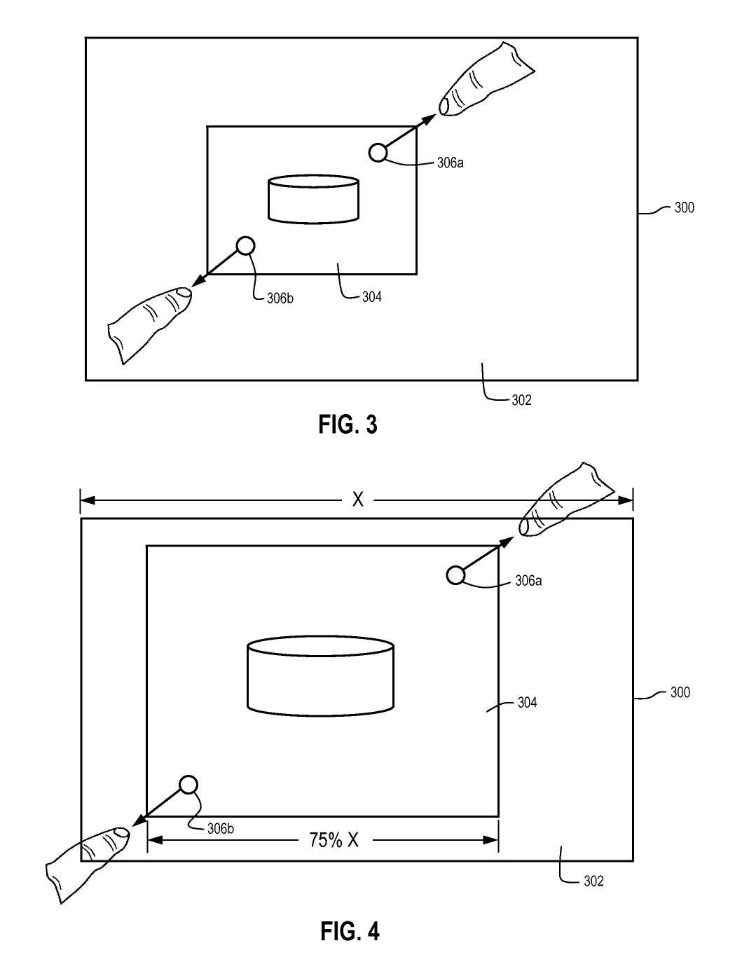

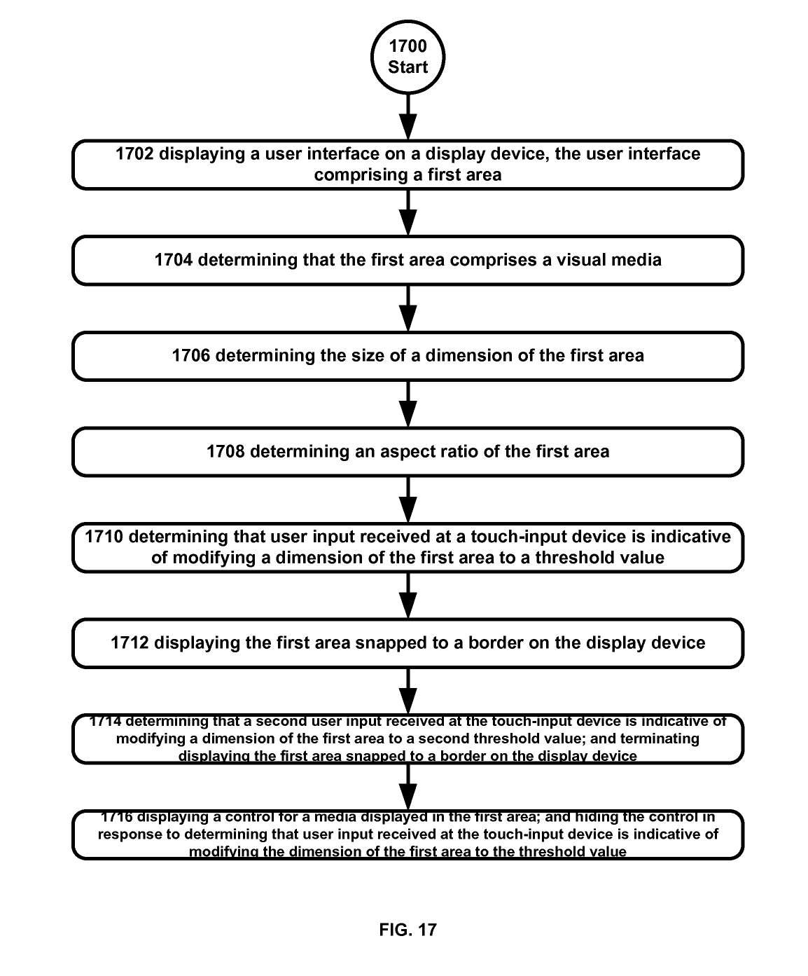

System memory 22 of computer 20 may comprise instructions that, upon execution by computer 20, cause the computer 20 to implement the invention, such as the operational procedures of FIG. 17, which are used to effectuate the aspects of the invention depicted in FIGS. 3-16.

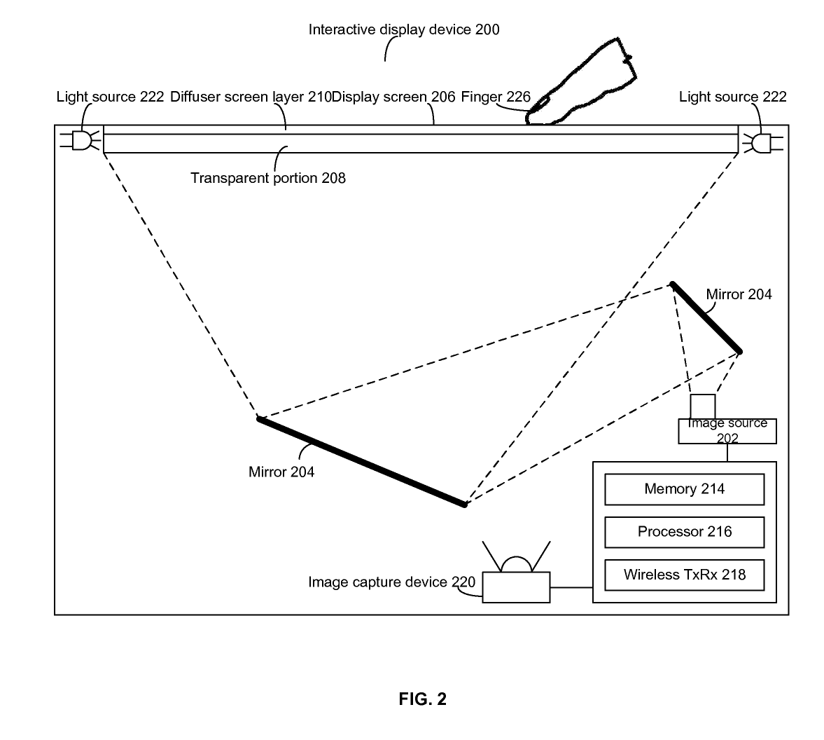

FIG. 2 depicts an example computer including a touch-sensitive surface in which an aspect of an embodiment of the invention can be implemented. The touch screen 200 of FIG. 2 may be implemented as the display 47 in the computing environment 100 of FIG. 1. Furthermore, memory 214 of computer 200 may comprise instructions that, upon execution by computer 200, cause the computer 200 to implement the invention, such as the operational procedures of FIG. 17, which are used to effectuate the aspects of the invention depicted in FIGS. 3-16.

The interactive display device 200 (sometimes referred to as a touch screen, or a touch-sensitive display) comprises a projection display system having an image source 202, optionally one or more mirrors 204 for increasing an optical path length and image size of the projection display, and a horizontal display screen 206 onto which images are projected. While shown in the context of a projection display system, it will be understood that an interactive display device may comprise any other suitable image display system, including but not limited to liquid crystal display (LCD) panel systems and other light valve systems. Furthermore, while shown in the context of a horizontal display system, it will be understood that the disclosed embodiments may be used in displays of any orientation.

The display screen 206 includes a clear, transparent portion 208, such as sheet of glass, and a diffuser screen layer 210 disposed on top of the clear, transparent portion 208. In some embodiments, an additional transparent layer (not shown) may be disposed over the diffuser screen layer 210 to provide a smooth look and feel to the display screen.

Continuing with FIG. 2, the interactive display device 200 further includes an electronic controller 212 comprising memory 214 and a processor 216. The controller 212 also may include a wireless transmitter and receiver 218 configured to communicate with other devices. The controller 212 may include computer-executable instructions or code, such as programs, stored in memory 214 or on other computer-readable storage media and executed by processor 216, that control the various visual responses to detected touches described in more detail below. Generally, programs include routines, objects, components, data structures, and the like that perform particular tasks or implement particular abstract data types. The term “program” as used herein may connote a single program or multiple programs acting in concert, and may be used to denote applications, services, or any other type or class of program.

To sense objects located on the display screen 206, the interactive display device 200 includes one or more image capture devices 220 configured to capture an image of the entire backside of the display screen 206, and to provide the image to the electronic controller 212 for the detection objects appearing in the image. The diffuser screen layer 210 helps to avoid the imaging of objects that are not in contact with or positioned within a few millimeters of the display screen 206, and therefore helps to ensure that only objects that are touching the display screen 206 (or, in some cases, in close proximity to the display screen 206) are detected by the image capture device 220. While the depicted embodiment includes a single image capture device 220, it will be understood that any suitable number of image capture devices may be used to image the backside of the display screen 206. Furthermore, it will be understood that the term “touch” as used herein may comprise both physical touches, and/or “near touches” of objects in close proximity to the display screen

The image capture device 220 may include any suitable image sensing mechanism. Examples of suitable image sensing mechanisms include but are not limited to CCD (charge-coupled device) and CMOS (complimentary metal-oxide-semiconductor) image sensors. Furthermore, the image sensing mechanisms may capture images of the display screen 206 at a sufficient frequency or frame rate to detect motion of an object across the display screen 206 at desired rates. In other embodiments, a scanning laser may be used in combination with a suitable photo detector to acquire images of the display screen 206.

The image capture device 220 may be configured to detect reflected or emitted energy of any suitable wavelength, including but not limited to infrared and visible wavelengths. To assist in detecting objects placed on the display screen 206, the image capture device 220 may further include an additional light source 222 such as one or more light emitting diodes (LEDs) configured to produce infrared or visible light. Light from the light source 222 may be reflected by objects placed on the display screen 222 and then detected by the image capture device 220. The use of infrared LEDs as opposed to visible LEDs may help to avoid washing out the appearance of projected images on the display screen 206.

FIG. 2 also depicts a finger 226 of a user's hand touching the display screen. While the embodiments herein are described in the context of a user's finger touching a touch-sensitive display, it will be understood that the concepts may extend to the detection of a touch of any other suitable physical object on the display screen 206, including but not limited to a stylus, cell phones, smart phones, cameras, PDAs, media players, other portable electronic items, bar codes and other optically readable tags, etc. Furthermore, while disclosed in the context of an optical touch sensing mechanism, it will be understood that the concepts disclosed herein may be used with any suitable touch-sensing mechanism. The term “touch-sensitive display” is used herein to describe not only the display screen 206, light source 222 and image capture device 220 of the depicted embodiment, but to any other suitable display screen and associated touch-sensing mechanisms and systems, including but not limited to capacitive and resistive touch-sensing mechanisms.

FIGS. 3-5 depict an example of a user manipulating an element via input to a touch-sensitive display. While the primary embodiment discussed in the detailed description is that of a touch-sensitive display, it may be appreciated that these techniques may be applied to other forms of direct manipulation, including digitizer pen input to a digitizer surface, voice input captured by a microphone, and body gesture or eye-tracking input provided to a motion capture device. FIG. 3 depicts an example touch-sensitive display (such as touch-sensitive display 200 of FIG. 2) 300 that displays web page 302 containing a video 304, which a user zooms using a reverse-pinch gesture made with two fingers 306a and 306b. This reverse-pinch gesture merely expands the video at the point depicted in FIG. 3, and does not snap it to a border (such as snap it to a full-screen mode).

FIG. 4 depicts the example touch-sensitive display of FIG. 3, as the user continues to zoom using a reverse-pinch gesture. At this point, the user has continued to diverge his fingers 306 in a reverse-pinch gesture. The video 304 is correspondingly larger or zoomed in as a result of this continued gesture. A dimension of the video 304—its width—has now reached a threshold to snap the video to a full-screen mode. As depicted, the width of video 304 is 75% of the width of the display area. Where 75% is the lower threshold for snapping a zooming video to a full-screen mode, the video may then be snapped to a full-screen mode.

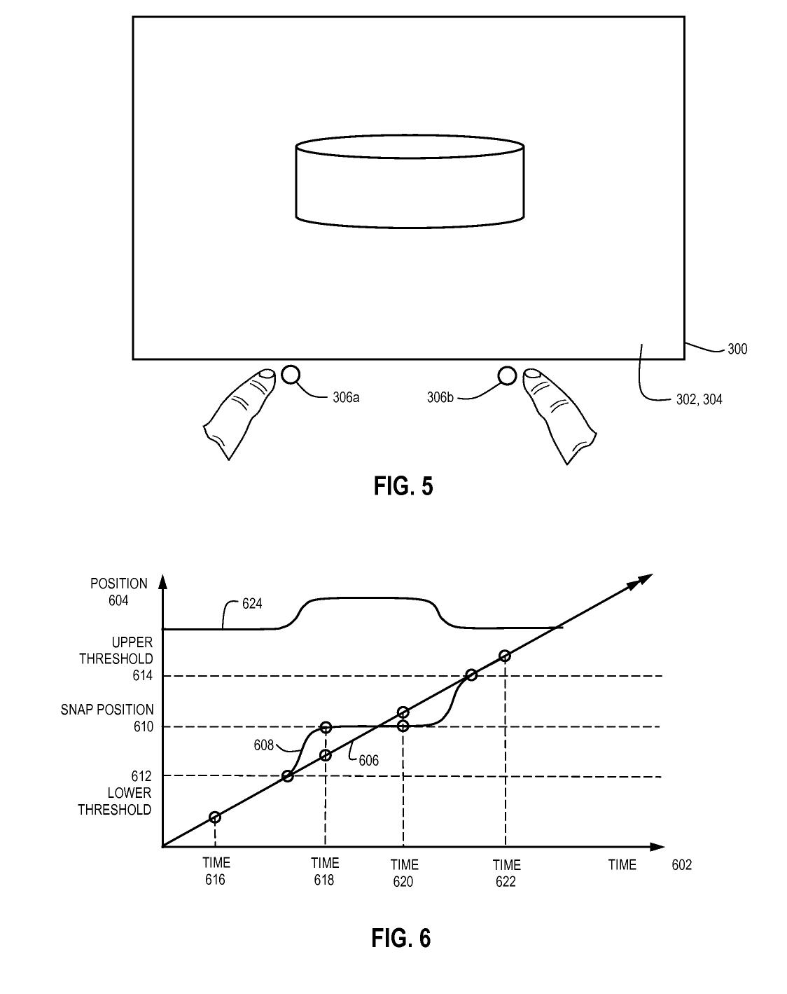

FIG. 5 depicts the example touch-sensitive display 300 of FIG. 4, after the user has zoomed using a reverse-pinch gesture (using fingers 306a and 306b) to reach a threshold where the invention causes the video 304 to be displayed in a full-screen mode. The video now occupies the entirety of the display area of touch-sensitive display 300, and no non-video portion of web page 302 is visible.

FIG. 6 depicts an example graph that compares the movement of a user's finger(s) over time and the position of an element manipulated by the user. The graph depicted in FIG. 6 may be used to determine when to snap the video of FIGS. 3-5 to a full-screen mode, or un-snap the video of FIGS. 3-5 from a full-screen mode.

The graph depicted in FIG. 6 plots time on the x-axis 602, and position from a reference point (as opposed to an absolute position) on the y-axis 604. Plotted on the graph are the position of a user's finger(s) over time 606, and the position of an element manipulated by the user over time 608. As depicted by the plot of the position of the user's finger(s) over time 606, the user moves his finger(s) at a constant rate of speed. The user moves his finger(s) to manipulate an element, but as depicted by the plot of the position of the element over time 608, the element does not move at a constant rate of speed. Rather, the element snaps to a snap position 610 when the element's position reaches a lower snap threshold 612. That is, as the user moves the element and it approaches the snap threshold (such as an edge of a display area), the element is snapped to the snap position 610 (shown in that the element's position does not change over time for a period, even though the user's finger(s), which is/are manipulating the element does/do).

It may be appreciated that the element does not instantly snap to the snap position 610 when the lower snap threshold 612 is reached (if this were the case, the position of the element between the lower snap threshold 612 and the snap position 610 would be graphed as a vertical line). Rather, the movement of the element is accelerated toward the snap position 610, as is reflected by that portion of the plot of the position of the element over time 608 having a steeper slope during that portion than during the preceding portion.

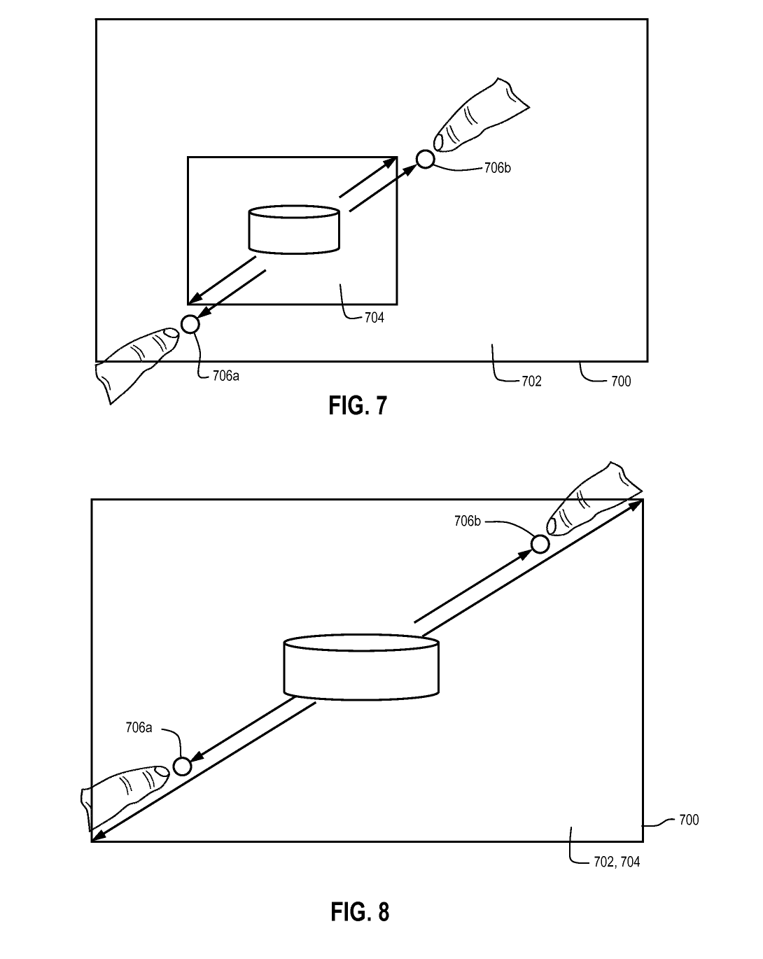

As the user continues to move his finger past the lower snap threshold 612 toward the upper snap threshold 614, the position of the element does not change, but remains at the snap position 610. When the position of the user's finger reaches the upper snap threshold 614, the position of the element “un-snaps” and moves at a greater rate of change than the position of the user's finger, until it catches up to the position of the user's finger. Elements 616, 618, 620, and 622 depict various times at which these movements occur, and will be explained in greater detail with respect to FIGS. 7-10.

Also depicted in FIG. 6 is the translation 624 of the element—its center point within a region. As the user moves his finger, not only is the element snapped and unsnapped from the snap position 610 when between the lower snap threshold 612 and the upper snap threshold 614, but the translation 624 of the element is changed when between the lower snap threshold 612 and the upper snap threshold 614. As depicted, the translation of the element increases when the position of the user's finger reaches the lower snap threshold 612, and then is maintained at this elevated level until the position of the user's finger reaches the upper snap threshold 614, where it is lowered to its original value.

FIGS. 7-10 depict the position of a user's finger(s) and of an element manipulated by the user at three respective different points in time relative to the graph of FIG. 6. In FIGS. 7-10, a web page 700 is displayed that contains an embedded video 702. The user moves his fingers 704 away from each other in a reverse pinch gesture to expand the video. FIGS. 7-10 depict the user performing operations that cause the following to occur: displaying a user interface on a display device, the user interface comprising a first area; determining that user input comprising direct manipulation of the user interface is indicative of modifying a dimension of the first area to a threshold value; displaying the first area snapped to a border on the display device, wherein prior to displaying the first area snapped to the border, the first area and the user input had a relative position; determining that second user input comprising direct manipulation of the user interface is indicative of modifying the dimension or position of the first area to a second threshold; displaying the first area unsnapped to the border on the display device; and displaying the first area in the relative position with a current position of the second user input. That is, after the element or first area snaps to the border, the position of the user's finger continues to move. Later, when the first area unsnaps, it catches up to the user's finger so that it has the same relative position with the finger as prior to the snapping. This is in contrast to current forms of indirect manipulation, where a unsnapped element does not catch up to a relative position with respect to the user's mouse (or other input device that he uses for indirect manipulation).

In FIG. 7, which depicts time 616 of FIG. 6, the user's fingers are diverging at the same rate that the video is expanding (or if the rate is not the same, there is a linear relationship between the rate at which the fingers diverge and at which the video expands). The translation 624 of the element 704 remains unchanged at this point—it is still centered below and to the left of the center of display area 700.

In FIG. 8, which depicts time 618 of FIG. 6, the user has expanded the video to the point that it has reached the lower snap threshold 612, and the video has now snapped to the snap position 610, which is depicted here as the border of the display area. In snapping to the snap position 610, the video has moved a larger amount than the fingers have since the time depicted in FIG. 7. The translation 624 of element 704 has now been changed. Whereas element 704 was originally not centered in display area 700, now element 704 is centered in display area 700.

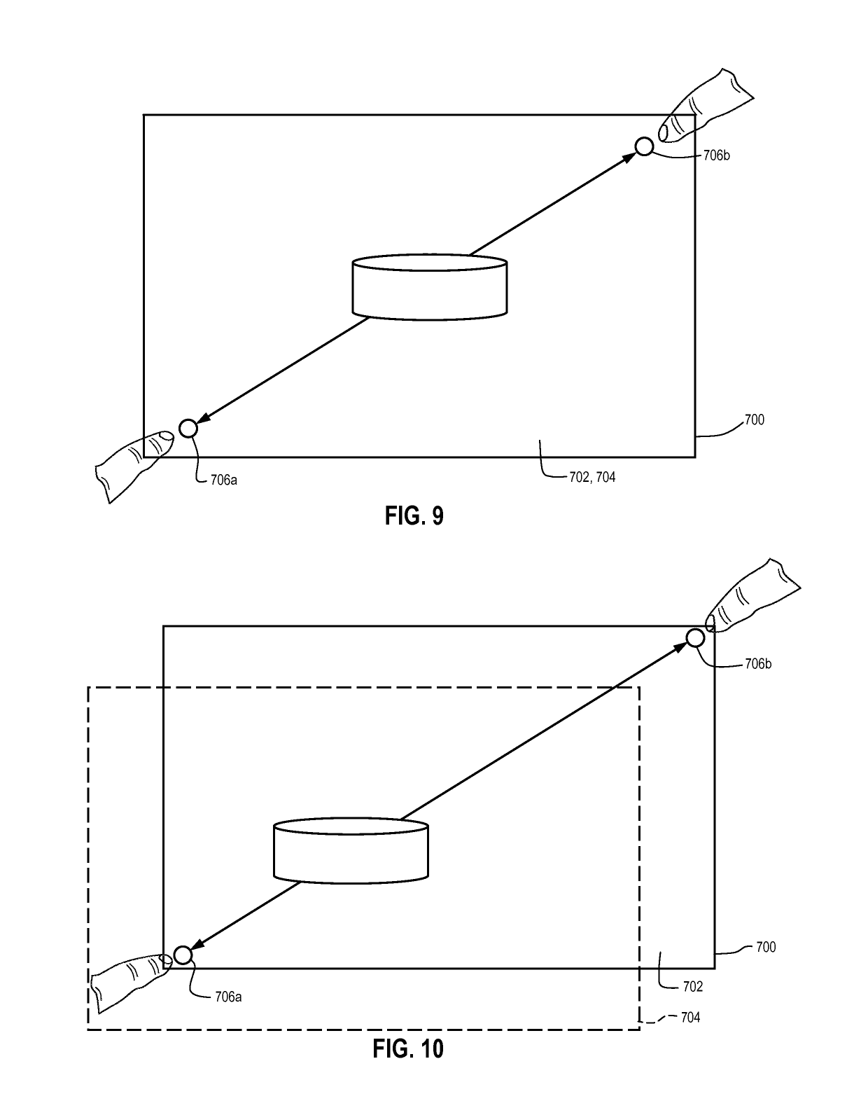

In FIG. 9, which depicts time 620 of FIG. 6, the user continues to diverge his fingers, though since the fingers are still within the area between the lower snap threshold 612 and the upper snap threshold 614, the position of the video does not change—it remains in a full-screen mode. Likewise, the translation 624 of element 704 remains the same as depicted in FIG. 8 (and different from that depicted in FIG. 7). Element 704 has been translated so that it is centered in display area 700.

In FIG. 10, which depicts time 622 of FIG. 6, the user has continued to diverge his fingers, and now they are past the upper snap threshold 614. Thus, the video has un-snapped, and continues to expand past the point where it is in a full-screen mode (so that some parts of the video are not displayed in the display area). The translation 624 of element 704 has returned to that of FIG. 7—being centered lower and to the left of the center of display area 700.

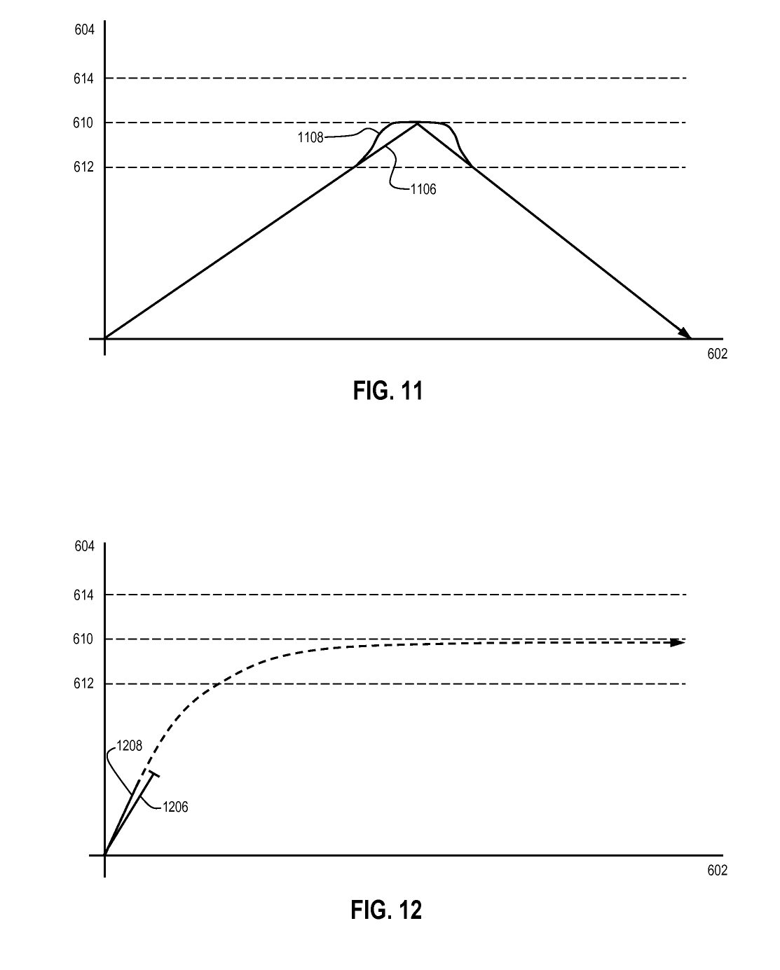

FIG. 11 depicts another example graph that compares the movement of a user's finger(s) over time and the position of an element manipulated by the user. The graph depicted in FIG. 11 may be used to determine when to snap the video of FIGS. 3-5 to a full-screen mode, or un-snap the video of FIGS. 3-5 from a full-screen mode. The graph depicted in FIG. 11 differs from the graph depicted in FIG. 6 in that, in FIG. 11, the user diverges, then converges his fingers, whereas in FIG. 6, the user only diverges his fingers.

In FIG. 11, the user diverges his fingers initially, and as the position of the fingers increases, so does the position of the element that the user is manipulating. When the position of the element reaches the lower snap threshold 612, it snaps to the snap position 610. After the element has snapped to the snap position 610, but before the position of the user's fingers have reached the upper snap threshold 614, the user changes the direction of his fingers. Whereas before they were diverging, now they are converging. Even though they begin to converge, the position of the element remains snapped to the snap position 610. It is only after the user has converged his fingers below the lower snap threshold 612 that the element un-snaps, and begins decreasing in size.

FIG. 12 depicts another example graph that compares the movement of a user's finger(s) over time and the position of an element manipulated by the user. The graph depicted in FIG. 11 may be used to determine when to snap the video of FIGS. 3-5 to a full-screen mode, or un-snap the video of FIGS. 3-5 from a full-screen mode. The graph depicted in FIG. 12 is similar to the graph depicted in FIG. 6, in that, in both FIGs., the position of the fingers monotonically increases. The graph depicted in FIG. 12 differs from the graph depicted in FIG. 6 in that, in FIG. 12, the makes a flick gesture where the gesture comprises a brief movement and an inertia calculated for the gesture is used to determine additional movement for the element being manipulated, whereas in FIG. 6, there is no such calculation, and the user is constantly providing true input.

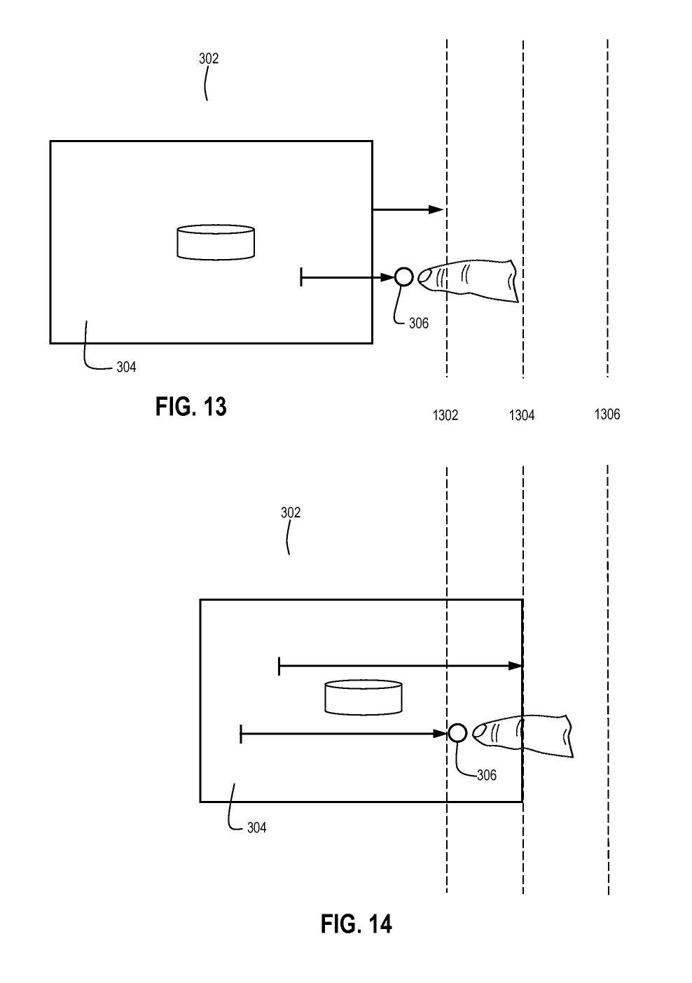

FIGS. 13, 14, 15, and 16 depict the position of a user's finger(s) and of an element manipulated by the user in a different manner than depicted in FIGS. 7-10 at four respective different points in time relative to the graph of FIG. 6.

In FIGS. 13-16, web page 302 is displayed which contains embedded video 304. The user moves his finger 306 to the right to move the video to the right. In FIG. 13, which depicts time 616 of FIG. 6, the user has moved his finger 306 some distance to the right, but has not met lower snapping threshold 1302, and there is a linear relationship between the rate and distance at which the finger 306 has moved and at which the video 304 has moved.

In FIG. 14, which depicts time 618 of FIG. 6, the user has moved his finger past the lower snapping threshold 1302 (but before the upper snapping threshold 1306). As a result, video 304 is snapped to snap position 1304. In snapping to the snap position 1304, the video has moved a larger amount than the finger 306 has since the time depicted in FIG. 13.

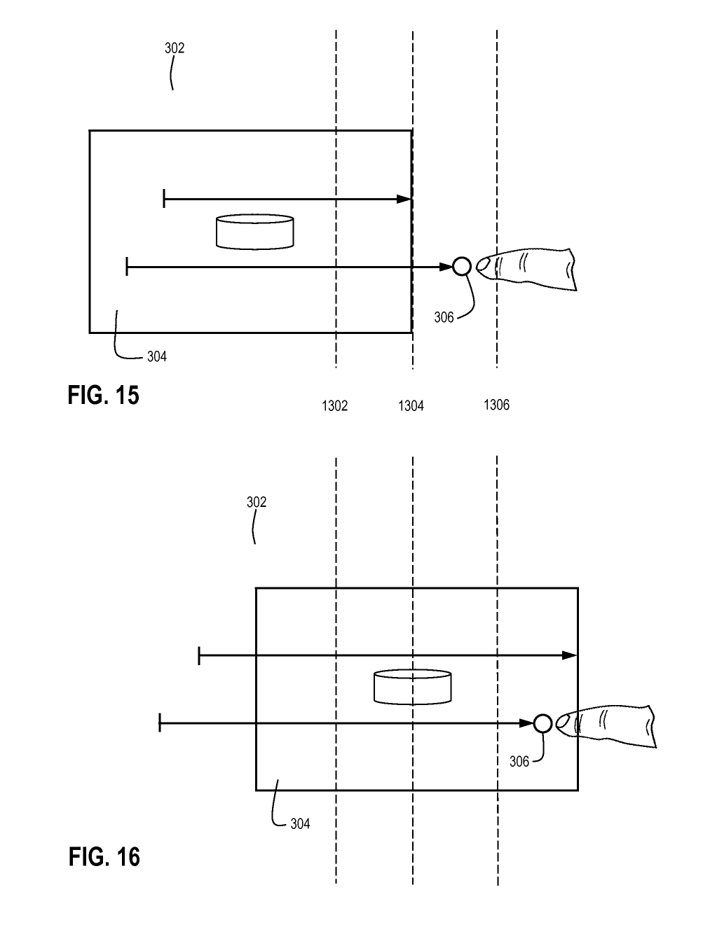

In FIG. 15, which depicts time 620 of FIG. 6, the user continues to move his finger 306 to the right, though since the finger 306 is still within the area between the lower snap threshold 1302 and the upper snap threshold 1306, the position of the video does not change—it remains snapped to snap position 1304.

In FIG. 16, which depicts time 622 of FIG. 6, the user has continued to move his finger 306 to the right, and now it is past the upper snap threshold 1306. Thus, the video 304 has un-snapped, and has “caught up” to the finger 306, such that the relative position between the finger 306 and the video 304 as depicted in FIG. 16 is the same as the relative position between the finger 306 and the video 304 as depicted in FIG. 13.

FIG. 17 depicts example operational procedures for using touch gestures to snap an area to a snap boundary. The operational procedures of FIG. 17 may be used to effectuate the user interface depicted in FIG. 3-5, 7-10, or 17-16, or the graphs plotting finger position and corresponding element position over time depicted in FIGS. 6, 11, and 12. The operational procedures of FIG. 17 begin with operation 1700. Operation 1700 leads into operation 1702.

Operation 1702 depicts displaying a user interface on a display device, the user interface comprising a first area. For instance, the user interface may comprise a web page, and the first area may comprise an embedded video that is embedded in that web page. The user interface in which the first area is displayed may occupy the entirety of the display device's visual output, or a subset thereof, such as a window that is displayed in part of the display device's visual output.

In an embodiment, the first area comprises an area in which a video may be displayed, an image, or a column of text. The first area may comprise such an area where a border or dimension may be defined, so that the border may be snapped to a snap border upon determining that the dimension is equal to a threshold.

Operation 1704 comprises determining that the first area comprises a visual media. This operation may comprise parsing a web page in which the video is displayed (such as by parsing Hyper Text Markup Language—HTML—and other code that make up the web page, or a Document Object Model—DOM—of a document) to determine that the first area contains a visual media, such as a video or an image.

Operation 1706 comprises determining the size of the dimension of the first area. As with operation 1704, this operation may comprise parsing a web page in which the video is displayed, such as by evaluating a “height” or “width” attribute that is defined for the first area in the web page.

Operation 1708 comprises determining an aspect ratio of the first area. As with operations 1704 and 1706, this may comprise parsing a web page in which the video is displayed, such as by evaluating both a “height” and a “width” attribute that is defined for the first area in the web page to determine an aspect ratio (the aspect ratio of visual media commonly being the ratio of the width to the height).

Operation 1710 depicts determining that user input received at a touch-input device is indicative of modifying a dimension of the first area to a threshold value. This user input may comprise a reverse-pinch gesture.

In an embodiment, operation 1710 includes determining that the user input is indicative of increasing the height, the width, a dimension or the area of the first area to a threshold value. The user may make touch input to move the first area, or zoom in on the first area. This user input may be processed as just that—moving the first area, or zooming the first area, respectively—so long as the input does not cause a dimension of the first area to be modified to a threshold value (such as zoomed until its width is at least 75% of the width of the display device's display area).

In an embodiment where the touch-input device and the display device comprise a touch screen, the user input is received at a location where the first area is displayed on the touch screen. It may be that the user is using a touch screen—where the display device itself is configured to accept user touch input on the display area. Where a touch screen is involved, the user may interact with the first area by touching the area of the touch screen where the first area is displayed.

Operation 1712 depicts displaying the first area snapped to a border on the display device. Upon determining that the user input has caused a dimension of the first area to equal a threshold value, the user interface may show the first area snapped to a border of the display device. This is not necessarily the border of the display device (the topmost, leftmost, rightmost, or bottommost part of the display area), but rather a “snap border”—a predefined place where elements (such as the first area) that have a dimension brought above a threshold are snapped to. For instance, a snap border may involve snapping the first area so that it is centered on the display device. Also, displaying the first area snapped to a border on the display device may comprise displaying the first area in a full-screen mode, where the border comprises the topmost, leftmost, rightmost, and bottommost parts of the display area.

In an embodiment, operation 1712 includes animating a transition from the dimension of the first area equaling a threshold value to displaying the first area snapped to a border on the display device. In an embodiment where the user input is indicative of increasing the size of the first area at a rate, and wherein animating the transition comprises animating the transition at a second rate, the second rate being greater than the rate. Once it has been determined to snap the first area to a border, it may be beneficial to perform this snap faster than the user manipulating the first area, so as to speed up the process.

In an embodiment, operation 1712 comprises, before displaying the first area in a full-screen mode, determining that a second user input received at the touch-input device is indicative of modifying the dimension below the threshold value; displaying the first area wherein the first area is not snapped to the border; and wherein displaying the first area snapped to the border occurs in response to determining that a third user input received at the touch-input device is indicative of modifying the dimension to the threshold value. After a user's input has caused the first area to reach a threshold value, he may still disengage the change to snapping the area to a border. The user may do this by performing a gesture that indicates manipulation of the first area in the opposite manner. For instance, where before he was diverging his fingers to zoom in, he may disengage by converging his fingers to zoom out, or where before he was moving his fingers to the right to move the element to the right, he may disengage by moving his fingers to the left to move the element to the left.

In an embodiment, operation 1712 comprises modifying the translation, pitch, or yaw of the first area in snapping it to the border. Translation refers to whether the first area is centered on the area in which it is snapped. For instance, where snapping the first area to the border comprises displaying the first area in a full-screen mode, and the first area is located below and to the left of the center point of the display area when this snapping is to initiate, the translation of the first area may be modified so that it is centered in the display area.

The pitch of the first area may also be changed when snapping it to a border. For instance, the first area and the display area may both be rectangles, and the border to snap the first area to may be the border of the display area. If the side of the first area to be snapped to the border is not parallel with the border, then there is a difference in pitch between the side of the first area and the border, and that is modified during the snapping process so that the edge is flush with the border. The yaw of the first area may also be modified in a similar manner as the pitch of an area. The yaw of the first area may be different from that of the border in certain scenarios, such as where the user interface is three-dimensional (3D) or has a z-depth in addition to a value within a x-y plane in a Cartesian coordinate system.

Operation 1714 depicts determining that a second user input received at the touch-input device is indicative of modifying a dimension of the first area to a second threshold value; and terminating displaying the first area snapped to a border on the display device. Once the first area is displayed snapped to the border, the user may provide input to disengage this snapping. This input may comprise continuing with his input as before which caused the snapping, or by providing differing input. For instance, as depicted in FIG. 6, the user may increase the zoom of the first area until a dimension reaches the lower threshold 612 and the first area is snapped to the snap position. Then, as the user continues to move his fingers and reaches the upper threshold 614, the first area may un-snap. In this case, the second threshold (the upper threshold) does not equal the threshold (the lower threshold), but is greater.

Likewise, as depicted in FIG. 11, the user may cause the first area to snap by increasing his finger position until the lower threshold is reached again. As depicted, both engaging and disengaging snapping are done at the lower threshold, but it may be appreciated where there are different threshold values for snapping the first area as a result of increasing finger position, and unsnapping the first area as a result of decreasing finger position.

Operation 1716 depicts displaying a control for a media displayed in the first area; and hiding the control in response to determining that user input received at the touch-input device is indicative of modifying the dimension of the first area to the threshold value. For instance, when the user causes the video in the first area to snap to a full-screen mode, this may be because the user wishes to sit back from the display and watch the video. In such an instance, the user experience may be improved by hiding these media controls when the video is snapped to a full-screen mode.

It may be appreciated that not all operations of FIG. 17 are needed to implement embodiments of the invention, and that permutations of the depicted operations may also be implemented in embodiments of the invention. For instance, an embodiment of the invention may implement operations 1702, 1710, and 1712. Likewise, an embodiment of the invention may perform operation 1706 before operation 1704.

### CONCLUSION

While the present invention has been described in connection with the preferred aspects, as illustrated in the various figures, it is understood that other similar aspects may be used or modifications and additions may be made to the described aspects for performing the same function of the present invention without deviating there from. Therefore, the present invention should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

1. A method for controlling a user interface with touch input, comprising:
displaying a user interface on a display device, the user interface comprising a first area;
determining that user input comprising direct manipulation of the user interface is indicative of modifying a dimension or position of the first area to a threshold value; and
displaying the first area snapped to a border on the display device.

2. The method of claim 1, wherein, prior to displaying the first area snapped to the border, the first area and the user input had a relative position, and further comprising:
determining that second user input comprising direct manipulation of the user interface is indicative of modifying the dimension or position of the first area to a second threshold;
displaying the first area unsnapped to the border on the display device; and
displaying the first area in the relative position with a current position of the second user input.

3. The method of claim 1, wherein the first area comprises an area in which a video may be displayed, the threshold value comprises a ratio of a dimension of the display device to the dimension of the first area, and displaying the first area snapped to a border on the display device comprises:
displaying the first area in a full-screen mode on the display device.

4. The method of claim 1, wherein determining that user input is indicative of modifying the area occupied by the first area to a threshold value comprises:
determining that the user input is indicative of increasing the height, the width, or the area of the first area above a threshold value.

5. The method of claim 1, wherein the user input comprises:
touch input made to a touch-input device with a finger or stylus, digitizer pen input to a digitizer tablet, voice input made to a microphone, or body gesture or eye movement made to a camera.

6. The method of claim 1, wherein the first area comprises an image.

7. The method of claim 1, further comprising:
determining that a second user input comprising direct manipulation of the user interface is indicative of modifying a dimension of the first area to a second threshold value; and
terminating displaying the first area snapped to a border on the display device.

8. The method of claim 1, further comprising:
animating a transition from the dimension of the first area equaling a threshold value to displaying the first area snapped to a border on the display device.

9. The method of claim 7, wherein the user input is indicative of increasing the size of the first area at a rate, and wherein animating the transition comprises:
animating the transition at a second rate, the second rate being greater than the rate.

10. The method of claim 1, further comprising:
before displaying the first area in a full-screen mode, determining that a second user input comprising direct manipulation of the user interface is indicative of modifying the dimension below the threshold value;
displaying the first area wherein the first area is not snapped to the border; and
wherein displaying the first area snapped to the border occurs in response to determining that a third user input comprising direct manipulation of the user interface is indicative of modifying the dimension to the threshold value.

11. The method of claim 1, further comprising:
displaying a control for a media displayed in the first area; and
hiding the control in response to determining that user input received at the touch-input device is indicative of modifying the dimension of the first area to the threshold value.

12. The method of claim 1, further comprising:
determining that the first area comprises a visual media.

13. The method of claim 1, further comprising: determining the size of the dimension of the first area.

14. The method of claim 1, further comprising:
determining an aspect ratio of the first area.

15. The method of claim 1, wherein the user interface comprises a web page, and the first area comprises an embedded video.

16. A system for controlling a user interface with touch input, comprising:
a processor; and
a memory communicatively coupled to the processor when the system is operational, the memory bearing instructions that, upon execution by the processor, cause actions comprising:
displaying a user interface on a display device, the user interface comprising a first area;
determining that user input comprising direct manipulation of the user interface is indicative of modifying a dimension of the first area to a threshold value; and
displaying the first area snapped to a border on the display device.

17. The system of claim 16, wherein determining that user input comprising direct manipulation of the user interface is indicative of modifying the area occupied by the first area to a threshold value comprises:
determining that the user input is indicative of modifying the height, the width, a diagonal, or the area of the first area to the threshold value.

18. The system of claim 16, wherein the memory further bears instructions that, upon execution by the processor, causes the processor to perform operations comprising:
before displaying the first area snapped to a border, determining that a second user input comprising direct manipulation of the user interface is indicative of modifying the dimension below the threshold value;
displaying the first area, wherein the first area is not snapped to the border; and
wherein displaying the first area snapped to the border occurs in response to determining that a third user input comprising direct manipulation of the user interface is indicative of modifying the dimension above the threshold value.

19. The system of claim 1, further comprising:
displaying a control for a media displayed in the first area; and
hiding the control in response to determining that user input received comprising direct manipulation of the user interface is indicative of modifying the dimension of the first area to the threshold value.

20. A computer-readable storage medium bearing computer-readable instructions that, upon execution by a computer, cause the computer to perform operations comprising:
displaying a user interface on a display device, the user interface comprising a first area;
determining that user input comprising direct manipulation of the user interface is indicative of modifying a dimension of the first area to a threshold value;
displaying the first area snapped to a border on the display device, wherein prior to displaying the first area snapped to the border, the first area and the user input had a relative position;
determining that second user input comprising direct manipulation of the user interface is indicative of modifying the dimension or position of the first area to a second threshold;
displaying the first area unsnapped to the border on the display device; and
displaying the first area in the relative position with a current position of the second user input.
